(19) United States
(12) Patent Application Publication
(10) Pub. No.: US 2021/0293550 A1
(43) Pub. Date: Sep. 23, 2021

(54) INFORMATION PROCESSING APPARATUS, INFORMATION PROCESSING METHOD, PROGRAM, AND STORAGE APPARATUS

(71) Applicant: SONY CORPORATION, TOKYO (JP)

(72) Inventor: TAKAHITO MIGITA, TOKYO (JP)

(21) Appl. No.: 17/250,316

(22) PCT Filed: Jun. 6, 2019
(86) PCT No.: PCT/JP2019/022504

§ 371 Date: Jan. 4, 2021

(30) Foreign Application Priority Data
Jul. 12, 2018 (JP) 2018-132309

(51) Int. Cl. G01C 21/34; G06Q 50/28; G01C 21/36

(52) U.S. Cl. CPC G01C 21/343; G01C 21/3691; G01C 21/3647; G06Q 50/28

(57) ABSTRACT

An information processing apparatus according to an embodiment of the present technology includes a calculating unit and an output unit. The calculating unit calculates a delivery route for delivering a delivery item. The output unit outputs an instruction for obtaining, during delivery of the delivery item, a relevant object related to an intermediate point between a start point of the delivery route and an end point of the delivery route to a relevant apparatus located at the intermediate point. Accordingly, it is possible to provide an information processing apparatus, an information processing method, and a program that are capable of realizing a new delivery service.

### TECHNICAL FIELD

The present technology relates to an information processing apparatus, an information processing method, a program, and a storage apparatus that can be applied to delivery of a delivery item.

### BACKGROUND ART

In recent years, various services related to delivery of delivery items have been developed. For example, in an activity prediction and a notification system described in Patent Literature 1, the actual activity of a delivery person is tracked and an area toward which the delivery person may move is predicted. A customer in the predicted area is notified of approach of the delivery person. This prevents loss of sales/purchase opportunities (paragraphs [0010] and [0049], FIG. 10, etc. of Patent Literature 1).

### CITATION LIST

### Patent Literature

Patent Literature 1: Japanese Patent Application Laid-open No. 2015-118401

### DISCLOSURE OF INVENTION

### Technical Problem

Various services related to delivery are expected to be further developed in the future, and it is desirable to provide a technology for realizing a new delivery service.

In view of the above-mentioned circumstances, it is an object of the present technology to provide an information processing apparatus, an information processing method, a program, and a storage apparatus that are capable of realizing a new delivery service.

### Solution to Problem

In order to accomplish the above-mentioned object, an information processing apparatus according to an embodiment of the present technology includes a calculating unit and an output unit.

The calculating unit calculates a delivery route for delivering a delivery item.

The output unit outputs an instruction for obtaining, during delivery of the delivery item, a relevant object related to an intermediate point between a start point of the delivery route and an end point of the delivery route to a relevant apparatus located at the intermediate point.

In this information processing apparatus, the delivery route for delivering the delivery item is calculated. The instruction for obtaining, during delivery of the delivery item, the relevant object related to the intermediate point located between the start point and the end point of the delivery route is output to the relevant apparatus located at the intermediate point. Accordingly, it is possible to additionally provide the relevant object related to the intermediate point in addition to the delivery of the delivery item. As a result, it is possible to realize a new delivery service.

The relevant object may include at least one of a scene image of the intermediate point, an environmental sound of the intermediate point, a smell of the intermediate point, and a real object located at the intermediate point.

The information processing apparatus may further include a content providing unit that provides a recipient of the delivery item with content related to the delivery route on the basis of the relevant object obtained by the relevant apparatus.

The content providing unit may generate image content obtained by editing at least one of scene images captured at a plurality of intermediate points each of which is the intermediate point.

The content providing unit may edit the scene image on the basis of a reproduction time specified by a sender of the delivery item.

The content providing unit may output, in a case where the recipient receives the delivery item, access information for accessing the content to a terminal owned by the recipient.

The relevant apparatus mat include at least one of a movable apparatus that is movable to the intermediate point together with the delivery item or a fixed apparatus installed at the intermediate point.

The relevant apparatus may include at least the movable apparatus. In this case, the movable apparatus may include at least one of a storage apparatus that stores the delivery item, a portable apparatus that is capable of being carried by a deliverer who delivers the delivery item, or a mounted apparatus that is mounted on a movable object that transports the delivery item.

The output unit may output at least one of an imaging instruction to an imaging apparatus located at the intermediate point, a sound recording instruction to a sound recording apparatus located at the intermediate point, a smell detecting instruction to a smell sensor located at the intermediate point, or an output instruction regarding obtaining a real object to the relevant apparatus located at the intermediate point.

The output unit may output an instruction for obtaining the relevant object in real time.

The calculating unit may calculate the delivery route including a plurality of specific landscapes as the intermediate point on the basis of the start point of the delivery route and the end point of the delivery route specified by a sender of the delivery item.

The output unit may output instructions for obtaining relevant objects to relevant apparatuses of a plurality of self-employed couriers respectively corresponding to the plurality of specific landscapes.

The information processing apparatus may further include a receiving unit that receives a condition related to the delivery of the delivery item, the condition being input from a sender of the delivery item. In this case, the calculating unit may calculate the delivery route on the basis of the received condition related to the delivery.

The condition related to the delivery may include a condition related to at least one of the intermediate point of the delivery route or the relevant object that is wished to be obtained.

The information processing apparatus may further include a presenting unit capable of presenting to a sender of the delivery item candidate route information including a plurality of candidate delivery routes that are candidates for the delivery route and delivery fees respectively depending on the plurality of candidate delivery routes.

An information processing method according to an embodiment of the present technology is an information processing method that is executed by at least one processor, the information processing method including calculating a delivery route for delivering a delivery item.

An instruction for obtaining, during delivery of the delivery item, a relevant object related to an intermediate point located between a start point of the delivery route and an end point of the delivery route is output to a relevant apparatus located at the intermediate point.

A program according to an embodiment of the present technology causes at least one processor to perform the following steps.

A step of calculating a delivery route for delivering a delivery item.

A step of outputting an instruction for obtaining, during delivery of the delivery item, a relevant object related to an intermediate point located between a start point of the delivery route and an end point of the delivery route to a relevant apparatus located at the intermediate point.

A storage apparatus according to an embodiment of the present technology includes a storage portion, a receiving unit, an obtaining unit, and a sending unit.

The storage portion is capable of storing a delivery item.

The receiving unit receives an instruction for obtaining, during delivery of the delivery item, a relevant object related to an intermediate point located between a start point of the delivery route and an end point of the delivery route from an information processing apparatus.

The obtaining unit is capable of obtaining data regarding the relevant object on the basis of the instruction.

The sending unit sends the data regarding the relevant object to the information processing apparatus.

The storage apparatus may further include a sensor unit that detects state information related to a delivery state of the storage apparatus. In this case, the obtaining unit may obtain the relevant object on the basis of the state information.

The state information may include at least one of a current location, an ambient illuminance, an ambient sound, acceleration, or a communication speed.

The obtaining unit may include at least one of an imaging apparatus capable of capturing a scene image of the intermediate point or a sound recording apparatus capable of obtaining an environmental sound of the intermediate point.

### Advantageous Effects of Invention

As described above, in accordance with the present technology, it is possible to realize a new delivery service. It should be noted that the effects described here are not necessarily limitative and any effect described in the present disclosure may be capturing an image related to the move point of the delivery item. The relevant object and the like related to the move point of the delivery item will be described later in detail. It should be noted that in the present disclosure, the “relevant object located at the move point (intermediate point)” may be considered as a relevant object existing at least within a predetermined distance from the position of the intermediate point.

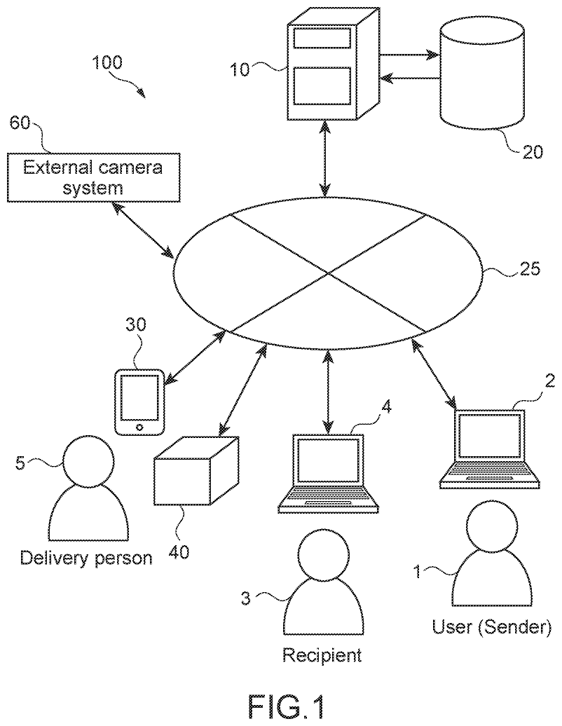

FIG. 1 A schematic diagram showing a configuration example of a delivery system according to an embodiment of the present technology.

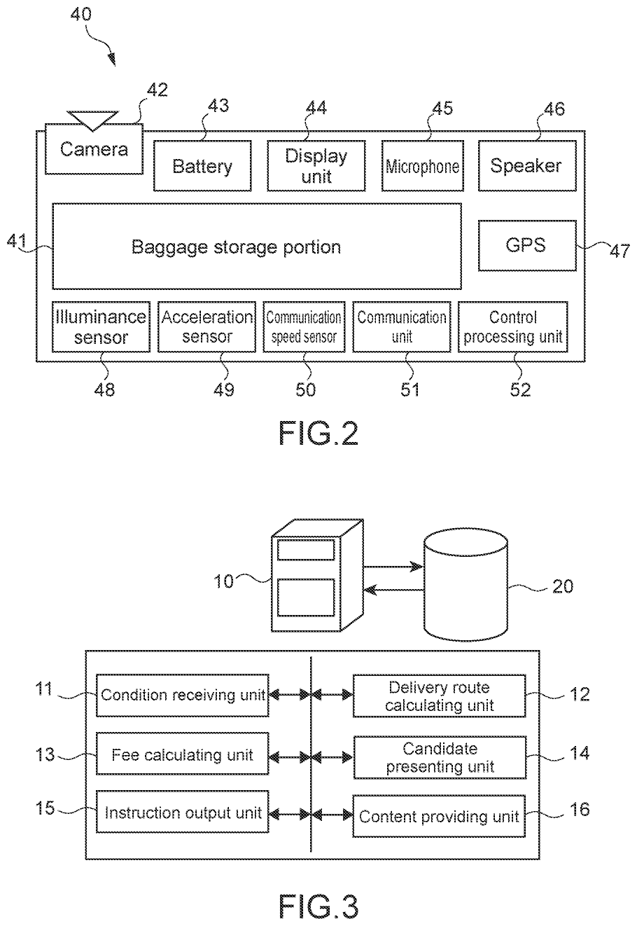

FIG. 2 A block diagram showing a configuration example of a dedicated box.

FIG. 3 A block diagram showing a functional configuration example of a server apparatus.

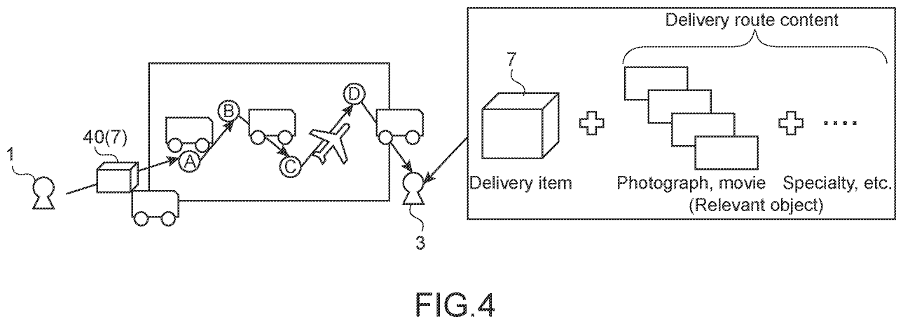

FIG. 4 A schematic diagram for describing the outline of delivery of a delivery item by this delivery system.

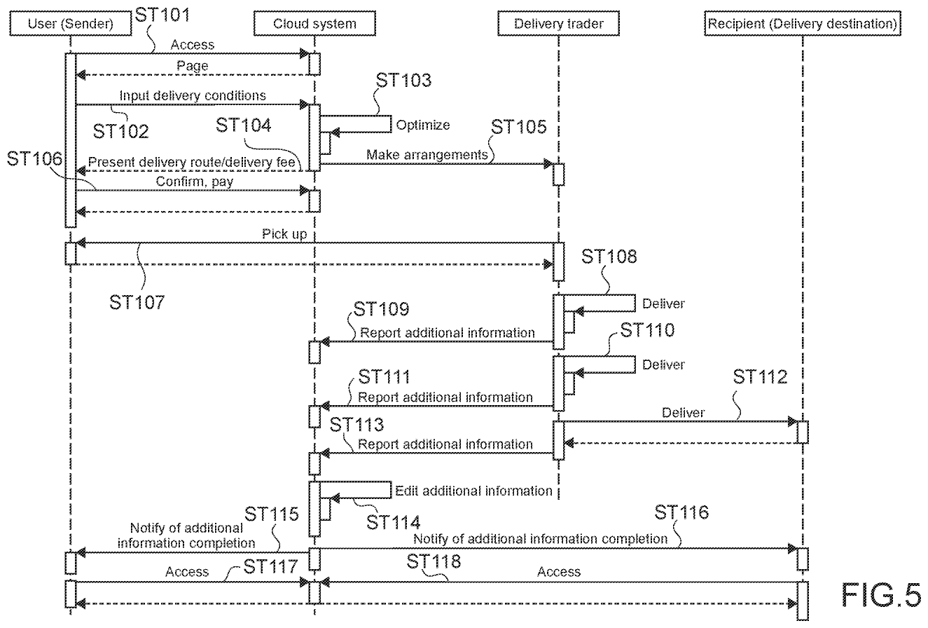

FIG. 5 A sequence diagram showing a specific processing example of delivery of the delivery item.

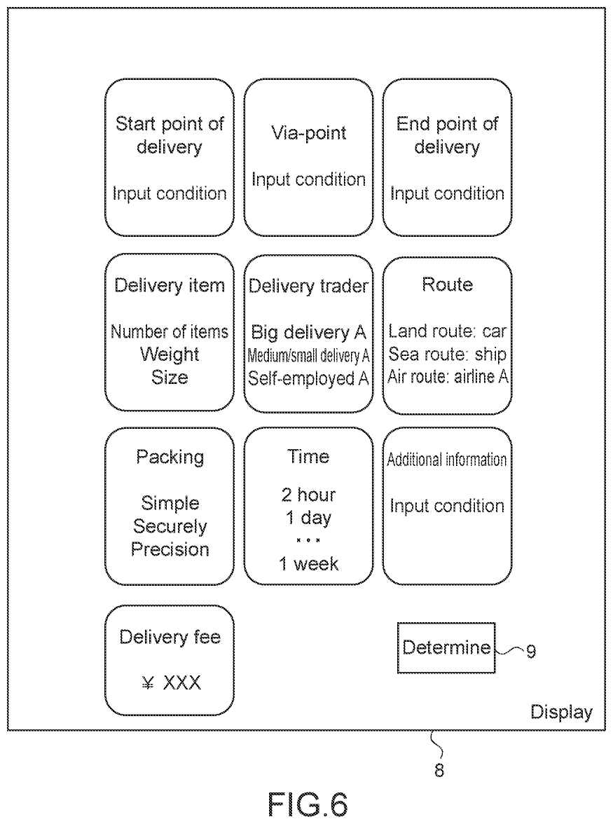

FIG. 6 A schematic diagram showing an example of a webpage for input.

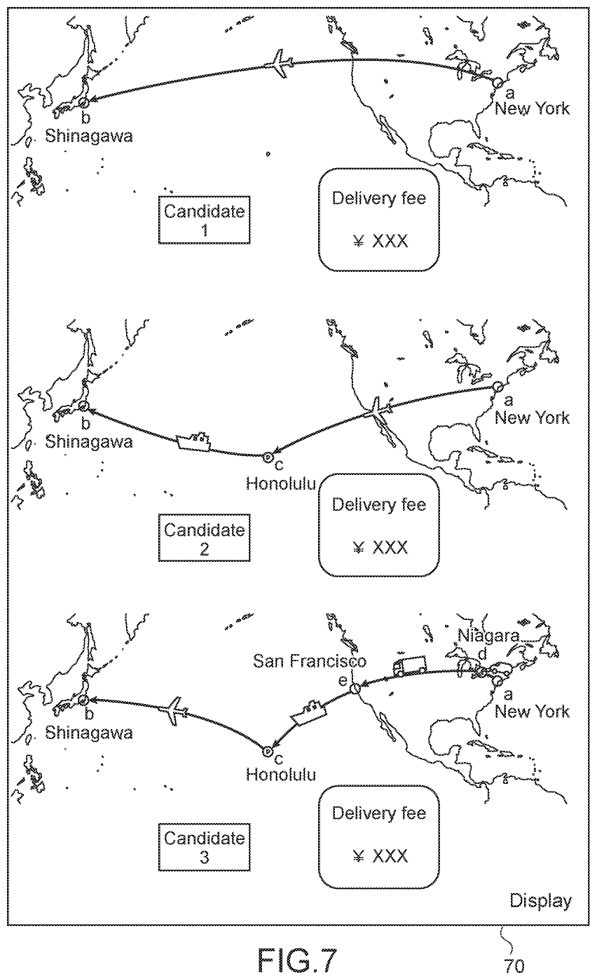

FIG. 7 A schematic diagram showing a configuration example of a webpage for route selection.

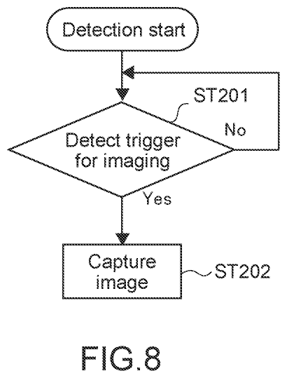

FIG. 8 A flowchart showing an example of obtaining a relevant object based on state information.

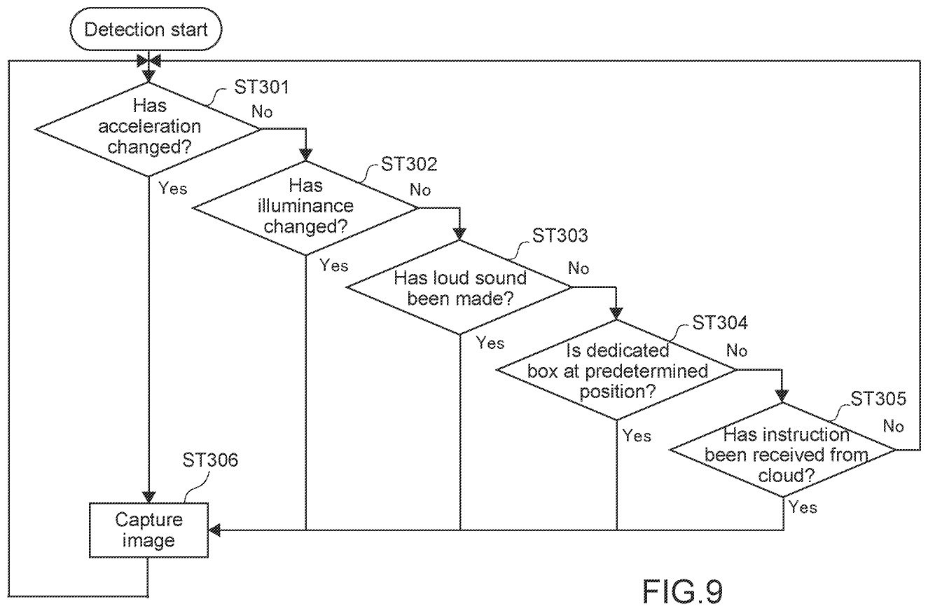

FIG. 9 A flowchart showing an example of a trigger for imaging.

Hereinafter, embodiments according to the present technology will be described with reference to the drawings.

[Delivery System]

FIG. 1 is a schematic diagram showing a configuration example of a delivery system according to an embodiment of the present technology. A delivery system 100 includes a server apparatus 10, a database 20, a network 25, a mobile terminal 30, a dedicated box 40, and an external camera system 60.

The server apparatus 10, the mobile terminal 30, the dedicated box 40 are communicably connected via the network 25. Further, the server apparatus 10 is capable of accessing the database 20 and record various types of information related to this delivery system 100 in the database 20. Further, the server apparatus 10 is capable of reading various types of information recorded in the database 20 and sending it to the mobile terminal 30 or the dedicated box 40.

The network 25 is constructed by the Internet, a wide area communication network, or the like, for example. Otherwise, a wide area network (WAN), a local area network (LAN), or the like may be used and a protocol for constructing the network 25 is not limited.

In this embodiment, it is possible to provide the delivery system 100 as a so-called cloud service to a user 1 (sender). The user 1 can access this delivery system 100 to request delivery of a delivery item by using a terminal (hereinafter, referred to as a user terminal) 2 such as a personal computer (PC). In this embodiment, a website related to this delivery system 100 is constructed. The user 1 can access a predetermined webpage in the website through the user terminal 2 to request the delivery of the delivery item or the like. As a matter of course, the present technology is not limited to such a method.

Further, in this embodiment, a notification or the like related to the delivery is also sent to a recipient 3 to which the delivery item is to be delivered. For example, various notification mails and the like are sent to a terminal (hereinafter, referred to as recipient terminal) 4 or the like such as a PC used by the recipient 3, for example. For example, the notification mail includes a uniform resource locator (URL) as access information for accessing the predetermined webpage related to this delivery system 100. The recipient can browse a webpage or the like including various types of notification information by operating the recipient terminal 4 to click the URL.

In this embodiment, the user terminal 2 corresponds to a terminal owned by a user. Further, the recipient terminal 4 corresponds to a terminal owned by a recipient.

The dedicated box 40 is a dedicated storage apparatus for storing delivery items. The delivery person (deliverer) 5 delivers the dedicated box 40 storing the delivery item to a delivery destination where the recipient 3 is located. Therefore, in this embodiment, delivering the dedicated box 40 means delivering the delivery item.

FIG. 2 is a block diagram showing a configuration example of the dedicated box 40.

The dedicated box 40 includes a baggage storage portion 41, a camera 42, a battery 43, a display unit 44, a microphone 45, a speaker 46, a GPS 47, an illuminance sensor 48, an acceleration sensor 49, a communication speed sensor 50, a communication unit 51, and a control processing unit 52.

The baggage storage portion 41 stores the delivery item of which the user 1 has requested delivery. The size and shape of the dedicated box 40 and the baggage storage portion 41 are not limited. For example, a plurality of types of dedicated boxes 40 including different sizes of baggage storage portions 41 may be prepared. For example, different types of dedicated boxes 40 may be used, each of which is defined as large/medium/small in size. Further, the delivery fee may vary depending on the size of the dedicated box 40.

The camera 42 images the periphery of the dedicated box 40 and obtains a captured image (scene image). The type of camera 42 is not limited. For example, a digital camera including an image sensor such as a complementary metal-oxide semiconductor (CMOS) sensor or a charge coupled apparatus (CCD) sensor may be used. Further, as the camera 42, a camera capable of imaging a 360 degree all-around area at a time may be used.

The battery 43 provides power to each block of the dedicated box 40. The type and number of batteries are not limited. For example, a solar cell or the like may be disposed outside the dedicated box 40.

The display unit 44 is capable of displaying graphical user interfaces (GUIs) as various images. The display unit 44 is constituted by a display device using liquid crystals, electro-luminescence (EL), or the like, for example. Further, a touch panel into which a user operation can be input may be configured as the display unit 44. In this case, the touch panel functions as a display unit and an operation unit.

The microphone 45 detects sounds around the dedicated box 40, i.e., environmental sounds. The type and number of microphones 45 are not limited. For example, the microphone 45 may be mounted on the camera 42. The speaker 46 outputs sounds. The type and number of speakers 46 are not limited.

The GPS 47 detects position information of the dedicated box 40. The specific configuration of GPS 47 and the algorithm for detecting the position information are not limited and may be arbitrarily set.

The illuminance sensor 48 detects illuminance around the dedicated box 40. The acceleration sensor 49 detects acceleration of the dedicated box 40. The communication speed sensor 50 detects a communication speed of network communication with the server apparatus 10 or the like. The specific configurations of the illuminance sensor 48, the acceleration sensor 49, and the communication speed sensor 50 are not limited and any configurations may be employed.

The communication unit 51 includes a communication module for communicating with other devices via a network such as a local area network (LAN) or a wide area network (WAN). Further, the communication unit 51 includes a communication module for performing short-range radio communication such as Bluetooth (registered trademark. In this embodiment, the communication unit 51 performs communication with the server apparatus 10 or the like via the network 25. As a matter of course, it may be possible to perform any other communication method as the communication method with the external apparatus.

The control processing unit 52 controls the operation of each block of the dedicated box 40. The control processing unit 52 has a hardware configuration necessary for a computer such as a processor (CPU) and a memory (RAM, ROM). The CPU loads programs and the like stored in the memory to the RAM and executes them for performing various types of processing.

For example, a programmable logic apparatus (PLD) such as a field programmable gate array (FPGA) or another device such as an application specific integrated circuit (ASIC) may be used as the control processing unit 52.

In this embodiment, the dedicated box 40 corresponds to a relevant apparatus related to a move point of the delivery item and a movable apparatus movable to the move point together with the delivery item. Further, the dedicated box 40 corresponds to a storage apparatus for storing the delivery item. It should be noted that the move point on a delivery route may be considered as an intermediate point between the start point and the end point of the delivery route.

Further, the baggage storage portion 41 corresponds to a storage portion capable of storing the delivery item. Further, the camera 42 and the microphone 45 function as an obtaining unit capable of obtaining a relevant object located at (i.e., related to) the move point of the delivery item. The camera 42 of them functions as an imaging apparatus capable of capturing an image related to the move point of the delivery item. The relevant object and the like related to the move point of the delivery item will be described later in detail. It should be noted that in the present disclosure, the “relevant object located at the move point (intermediate point)” may be considered as a relevant object existing at least within a predetermined distance from the position of the intermediate point.

Further, in this embodiment, the microphone 45, the GPS 47, the illuminance sensor 48, the acceleration sensor 49, and the communication speed sensor 50 correspond to a sensor unit that detects state information related to the state of the dedicated box 40. The state information related to the state of the dedicated box 40 includes, for example, at least one of a current location, an ambient illuminance, an ambient sound, acceleration, or a communication speed. As a matter of course, other information may be obtained as the state information.

Further, the communication unit 51 also functions as a receiving unit that receives an instruction for obtaining a relevant object related to the move point of the delivery item and a sending unit that sends the obtained relevant object to the server apparatus 10 directly or indirectly through the mobile terminal 30. It should be noted that the control processing unit 52 that controls the operation of each block can also function as a part of the obtaining unit, the sensor unit, the receiving unit, and the sending unit.

The mobile terminal 30 shown in FIG. 1 is a terminal that can be carried by the delivery person 5. A smartphone, a tablet terminal, or the like is used as the mobile terminal 30, for example. The mobile terminal 30 has a communication function capable of communication via the network 25, an imaging function capable of imaging the periphery, and the like.

In this embodiment, the mobile terminal 30 corresponds to a relevant apparatus related to the move point of the delivery item, a movable apparatus movable to the move point together with the delivery item, and a portable apparatus that can be carried by a deliverer who delivers the delivery item.

The external camera system 60 includes, for example, fixed cameras (fixed point cameras) installed in various points in the world, cameras mounted on movable objects such as cars, ships, airplanes, and drones that transport delivery items, and the like. For example, permission to obtain and use captured images is obtained from a system that manages each camera.

In this embodiment, each camera included in the external camera system 60 corresponds to a relevant apparatus related to the move point of the delivery item. The fixed cameras and the like installed in each point in the world of them each correspond to fixed apparatus installed at the move point.

Further, the cameras mounted on the mobile objects such as cars, ships, airplanes, and drones used for delivery and the like each correspond to a mobile apparatus movable to the move point together with the delivery item, and a mounted apparatus that is mounted on the mobile apparatus that transports the delivery item.

FIG. 3 is a block diagram showing a functional configuration example of the server apparatus 10.

The server apparatus 10 includes hardware necessary for computer configurations such as a CPU, a ROM, a RAM, and an HDD, for example. The CPU loads into the RAM a program according to the present technology that has been recorded on the ROM or the like and executes it for configuring each block shown in FIG. 3 and performing an information processing method according to the present technology.

For example, the server apparatus 10 can be realized by an arbitrary computer such as a PC. As a matter of course, hardware such as an FPGA and an ASIC may be used. Further, in order to realize each block shown in FIG. 3, dedicated hardware such as an integrated circuit (IC) may be used.

The program is installed in the server apparatus 10 via various recording media, for example. Alternatively, the program may be installed via the Internet or the like.

As shown in FIG. 3, the server apparatus 10 includes a condition receiving unit 11, a delivery route calculating unit 12, a fee calculating unit 13, a candidate presenting unit 14, an instruction output unit 15, and a content providing unit 16. It should be noted that in this embodiment, the server apparatus 10 corresponds to an information processing apparatus.

The condition receiving unit 11 receives various conditions related to the delivery of the delivery item. For example, the user 1 inputs various conditions related to the delivery through the user terminal 2 and specifies at least a start point and an end point of the delivery route. It should be noted that the condition receiving unit 11 may request the user 1 to further input at least one of an intermediate point of the delivery route or a relevant object that the user 1 wishes to obtain. When the user 1 inputs the conditions related to the delivery, an input signal corresponding to the input of the condition is sent from the user terminal 2 to the server apparatus 10 via the network 25. The condition receiving unit 11 receives the conditions related to the delivery of the delivery item on the basis of the input signal sent from the user terminal 2.

The delivery route calculating unit 12 calculates a delivery route for delivering the delivery item. In this embodiment, the delivery route is calculated on the basis of the conditions related to the delivery received by the condition receiving unit 11. Further, the delivery route calculating unit 12 is also capable of calculating one or more candidate delivery routes that are candidates for the delivery route. It should be noted that the delivery route calculating unit 12 desirably presents a plurality of candidate delivery routes to the user. With such a configuration, it is possible to provide the user 1 with an experience value of making a plan to make the delivery item travel rather than simply sending the delivery item.

The fee calculating unit 13 calculates a delivery fee depending on the delivery route calculated by the delivery route calculating unit 12. For example, the delivery fee is calculated on the basis of the conditions related to the delivery input by the user 1 and the calculated delivery route.

The candidate presenting unit 14 generates candidate route information and presents it to the user 1. The candidate route information includes the one or more candidate delivery routes that are the candidates for the delivery route, which are calculated by the delivery route calculating unit 12, and the delivery fees respectively depending on the one or more candidate delivery routes, which are calculated by the fee calculating unit 13. The candidate route information generated by the candidate presenting unit 14 is sent to the user terminal 2 via the network 25 and displayed on a display of the user terminal 2. It should be noted that presenting the candidate route information includes making the user to access a webpage including the candidate route information.

The instruction output unit 15 outputs an instruction for obtaining the relevant object related to the move point of the delivery item that moves on the basis of the calculated delivery route during delivery of the delivery item to the relevant apparatus related to the move point of the delivery item. For example, the instruction output unit 15 sends the instruction for obtaining the relevant object to the dedicated box 40, the mobile terminal 30, and the external camera system 60. It should be noted that a part of the relevant object does not necessarily need be obtained during delivery, i.e., in real time. As described later, for example, an image obtained from the Internet may be used.

The relevant object is an object capable of expressing the feature of the move point. For example, the relevant object includes at least one of an image showing a scene of the move point of the delivery, an environmental sound of the move point, a smell of the move point, and a real object (e.g., specialty product) existing at the move point. It should be noted that the real object in the present disclosure is defined as an object that does not include invisible objects such as smell particles. Hereinafter, a specialty product will be shown as an example of the real object, though the real object in the present disclosure is not limited thereto. The real object in the present disclosure only needs to be a real object that can remain in the memory of a person who has been to the move point and may be a general-purpose product that is not a specialty product. The manner of expressing the feature of the move point is not limited, and includes, for example, any manner of expressing that can be felt through the five senses of the person who has been to the move point.

For example, the relevant object includes any object capable of expressing a feature which enables the user to feel as if the user actually visited the move point, for example, an image obtained by imaging a sunset or the like at the move point (sense of vision), a sound heard at the move point (sense of hearing), a smell of flowers blooming at the move point or a smell of the specialty product (sense of smell), a texture of a building standing at the move point or the specialty product (sense of touch), a taste of a dish cooked at the move point or specialty product (sense of taste).

Further, the relevant object is not limited to a substantial object existing in reality. For example, the relevant object also includes invisible objects such as image data and smell data. Further, the relevant object also includes information and data that can reproduce a smell, a taste, and the like. For example, the relevant object also includes image data captured at the move point, data regarding a smell, a tactile sense, and the like detected at the move point, and the like.

For example, the instruction output unit 15 outputs at least one of an imaging instruction to an imaging apparatus located at the intermediate point, a sound recording instruction to a sound recording apparatus located at the intermediate point, a smell detecting instruction to a smell sensor located at the intermediate point, or an output instruction regarding obtaining of the specialty product to the relevant apparatus located at the intermediate point as the instruction for obtaining the relevant object. It should be noted that each apparatus does not need to exist at the intermediate point at the time when each imaging instruction is output. Each apparatus only needs to at least temporarily exist at the intermediate point at the time when the instruction is performed.

For example, the instruction output unit 15 outputs an imaging instruction for automatically capturing an image to the camera 42 of the dedicated box 40, the camera of the mobile terminal 30, or the external camera system 60. Further, the instruction output unit 15 outputs a sound recording instruction for automatically recording an ambient sound through the microphone 45 (sound recording apparatus) of the dedicated box 40.

Further, the instruction output unit 15 outputs an instruction for outputting text data or audio data saying “Please purchase (the specialty product)”, for example, via the display unit 44 or the speaker 46 as an instruction for causing the delivery person 5 to obtain the specialty product or the like as the instruction for obtaining the relevant object.

It should be noted that the specialty product that is an object to be purchased may be specified or may be selected as appropriate by the delivery person 5. Specifically, an instruction in which the object to be purchased is specified saying “Please buy a durian here,” “Please buy high-grade oolong tea here,” or “Please buy a key holder of this building”, for example may be output. Alternatively, the delivery person 5 may be allowed to have a choice as to what to buy by outputting an instruction saying “Please buy a specialty product here”, for example. The purchased specialty product is typically stored in the dedicated box 40 and delivered to the recipient 3 together with the delivery item.

It should be noted that an instruction for capturing an ambient image or an instruction for recording an ambient sound may be output to the delivery person 5 via the display unit 44 or the speaker 46. In this case, an instruction for outputting the instruction for capturing the image or the instruction for recording the sound is output as the instruction for obtaining the relevant object.

The content providing unit 16 provides the recipient 3 of the delivery item with content related to the delivery route (hereinafter, referred to as delivery route content) on the basis of the relevant object obtained by the relevant apparatus. That is, the content providing unit 16 provides the delivery route content to the recipient 3 of the delivery item on the basis of the relevant objects obtained by the dedicated box 40, the mobile terminal 30, and the external camera system 60.

The delivery route content includes the relevant objects obtained by the dedicated box 40 and the like, those obtained by editing the obtained relevant objects, those reproduced through the obtained relevant objects, and the like.

For example, the delivery route content includes image data captured at the move point, edit data obtained by editing image data (scene images) of a scene imaged at respective move points, i.e., imaged at a plurality of intermediate points, and the like as image content. This image data may be obtained as a single piece of data including the scene images of the plurality of intermediate points or may be obtained as a plurality of pieces of data respectively corresponding to the plurality of intermediate points. Further, the delivery route content includes audio data recorded at the move point, edit data obtained by editing the audio data, and the like.

Further, the delivery route content also includes those that reproduce the smell, the texture, and the like obtained as the relevant objects, for example, a smell generated from a predetermined smell generating apparatus, an object that enables the user to feel the same texture, and the like. Further, the delivery route content also includes the specialty product and the like obtained at the move point. Further, the delivery route content also includes a dish that reproduces a dish cooked at the move point. Additionally, the delivery route content includes any content based on the obtained relevant objects.

The content providing unit 16 is capable of performing arbitrary processing for providing such delivery route content to the recipient 3 of the delivery item. For example, a video (including image data and audio data) obtained by each of the dedicated box 40, the mobile terminal 30, and the external camera system 60 is edited as appropriate and the resulting video that enables the user to feel as if the user travelled on the delivery route is generated as the delivery route content.

In a case where the recipient 3 receives the delivery item, the content providing unit 16 sends a URL that is access information for accessing video content generated as the delivery route content to the recipient terminal 4. The recipient can view the video by operating the recipient terminal 4 to click the URL.

Additionally, the content providing unit 16 performs arbitrary processing such as arranging the smell generating apparatus and instructing the generation of a smell, arranging a predetermined object or dish, and sending predetermined data. For example, an e-mail may be sent containing the URL of a particular website such that image data, sound data, and smell data can be downloaded from the network.

In a case where a relevant object related to the sense of vision is obtained, the delivery route content may be provided such that, a scene image (still image or video) of the place can be reproduced by augmented reality (AR), virtual reality (VR), a hologram, or the like, for example.

In a case where a relevant object related to the sense of smell is obtained, a smell generating apparatus or an object capable of reproducing the obtained smell may be delivered to the recipient 3, for example. Such a smell generating apparatus or the like may be delivered together with the delivery item or may be separately delivered after the delivery item is delivered.

In a case where a relevant object related to the sense of hearing is obtained, audio data may be provided or a URL accessible to audio data may be sent as with the image data.

In a case where a relevant object related to the sense of taste is obtained, the obtained dish, specialty product, or the like may be delivered together with the delivery item. Alternatively, the reproduced dish may be delivered to the recipient 3 after the delivery item is delivered.

In this embodiment, the condition receiving unit 11 functions as a receiving unit. The delivery route calculating unit 12 functions as a calculating unit. The instruction output unit 15 functions as an output unit. The candidate presenting unit 14 functions as a presenting unit. The content providing unit 16 functions as a content providing unit. Further, the receiving unit, the calculating unit, the output unit, the presenting unit, and the content providing unit may be each realized by the respective blocks cooperating as appropriate.

[Delivery of Delivery Item]

FIG. 4 is a schematic diagram for describing the outline of the delivery of the delivery item by this delivery system 100.

The user 1 requests this delivery system 100 to deliver the delivery item 7 to the recipient 3. For example, the user 1 requests this delivery system 100 to deliver the delivery item 7 to the recipient 3 via Yankee Stadium (point A), Liberty Island (point B), Niagara Falls (point C), and Shinagawa Station (point D) in the stated order as the delivery route. Hereinafter, points corresponding to points of interest (POIs) generally set in a map, such as the Yankee Stadium, the Liberty Island, and the Niagara Falls, will be sometimes referred to as specific landscapes.

The user 1 requests to obtain images and sounds of the delivery route via the Yankee Stadium (point A), the Liberty Island (point B), the Niagara Falls (point C), and the Shinagawa Station (point D) and specialty products related to the Yankee Stadium (point A), the Liberty Island (point B), the Niagara Falls (point C), and the Shinagawa Station (point D) as the relevant objects.

On the basis of the above-mentioned condition of the user 1, a delivery route and a delivery fee are calculated and presented. For example, a delivery method on a delivery route connecting the respective via-points (intermediate points) is presented. Here, the calculating unit 13 may calculate a delivery route to include the plurality of specific landscapes as the via-points. For example, the user 1 can select which one of a land route by car, railway, or the like, a sea route by ship or the like, and an air route by airplane or the like is to be used as the delivery route from the point A to the point B or the like.

The delivery fee is calculated on the basis of, for example, the predetermined condition input by the user 1 and the calculated delivery route. For example, a higher delivery fee is calculated depending on the number of via-points on the delivery route, the baggage size, express delivery, or the like.

By the user 1 requesting the delivery as described above, the delivery item 7 as well as the images of the via-points such as the Yankee Stadium, the Statue of Liberty, the Niagara Falls, and the Bell of Hope, which are related to the points A, B, C, and D through which the delivery item 7 has passed, the images of the delivery route to those via-points, and specialty products related to the points A, B, C, and D, are delivered to the recipient 3.

Accordingly, the recipient 3 can feel the atmosphere of the delivery route from the images, sounds, and specialty products obtained when the delivery item 7 delivered to the user 1 passes through the points A, B, C, and D, and can have a simulated travel experience. Further, by providing the delivery route content including the images and the like in addition to the delivery item 7, it is possible to add value to the distribution.

FIG. 5 is a sequence diagram showing a specific processing example of the delivery of the delivery item.

For example, it is assumed that a user 1 living in an apartment near Central Park in New York sends a gift as the delivery item to a recipient 3, friend living in an apartment near Shinagawa Station. The user 1 requests the delivery by using this delivery system 100 advertised as a service that offers a simulated travel experience.

The user 1 accesses a “custom distribution service” which is a website of this delivery system 100 through the user terminal 2 (Step 101). The user 1 opens a webpage for input for inputting a condition (delivery condition) regarding the delivery of the delivery item and inputs the delivery condition (Step 102).

The delivery condition regarding the delivery of the delivery item includes a condition related to at least one of a delivery start point (start point of the delivery route), a via-point (intermediate point), a delivery end point (end point of the delivery route), the number of delivery items, the weight of the delivery item, the size of the delivery item, a delivery trader, a delivery method, a time for delivery, a delivery fee, and the relevant object that the user wishes to obtain. It should be noted that in this embodiment, the condition related to the delivery of the delivery item corresponds to a condition related to the delivery.

FIG. 6 is a schematic diagram showing an example of the webpage for input. In this embodiment, it is possible to input conditions related to the “delivery start point”, “via-point”, “delivery end point”, “delivery item”, “delivery trader”, “route”, “packing”, “time”, “additional information”, and “delivery fee” via a webpage for input 8.

The “delivery start point” is a point at which the user 1 wishes to start the delivery. For example, the address of the user 1, a sightseeing spot near the place where the user 1 lives, or the like is input. Additionally, the user 1 may input an arbitrary point that the user 1 wishes to set as a start point of the travel.

The “via-point” is a point through which the delivery item passes. For example, the Yankee Stadium (point A), the Liberty Island (point B), the Niagara Falls (point C), and the Shinagawa Station (point D) described above with reference to FIG. 4 or the like are input.

The “delivery end point” is an end point of the delivery, and the place where the recipient 3 lives is input, for example. Alternatively, an arbitrary point at which the recipient 3 can receive the delivery item may be input as the delivery end point. It should be noted that it is also possible to input the same point as the delivery start point as the delivery end point and deliver the delivery item returned after travelling through the via-point to the sender himself/herself or a roommate.

As described above, since the “delivery start point”, “via-point”, and “delivery end point” can be arbitrarily set, it is possible to make the recipient 3 have a simulated experience of a travel that the user 1 wishes to experience or the like. Further, it is possible to obtain the relevant object related to the delivery route set by the user 1 on purpose.

For example, the number of items, weight, size, and the like of the delivery item to be delivered are input as conditions related to the “delivery item”. The specific input method of each condition is not limited. It may be possible to directly input numerical values of the weight and the like or it may be possible to select a specific range of weight of 1 kg or more and less than 3 kg or the like.

The “delivery trader” is a delivery trader in charge of delivering the delivery item. For example, the user 1 inputs “big delivery company”, “medium/small delivery company”, “self-employed courier”, or the like. The user 1 can specify and input the delivery trader. As a matter of course, it is also possible to cause a plurality of delivery traders to share the delivery. It should be noted that the instruction output unit 15 may output an instruction to obtain the relevant object to terminals of a plurality of self-employed couriers to cause the plurality of self-employed couriers respectively corresponding to a plurality of specific landscapes on the delivery route to share the delivery. By configuring the instruction output unit 15 in this manner, the diversity (prediction difficulty) of the additional information to be finally generated increases. As a result, it is expected that the value increases as a surprise gift that is the additional information for the recipient 3. Therefore, the self-employed courier may be randomly selected from the database 20. As a matter of course, a plurality of self-employed couriers may be in charge of some of the intermediate points and a big delivery company or medium/small delivery company may be in charge of the other intermediate points.

A condition regarding the delivery method is input for the “route”. For example, the user 1 selects a land route, a sea route, or an air route. For example, delivery only by sea route, delivery only by air route, or the like is input. Alternatively, an input to use the air route for the via-points A to B and the sea route for the via-points B to C is also possible.

Further, the type of movable object to be used for the delivery and the like are input. For example, in a case of the land route, delivery by car or delivery by railway is input. Further, it may be possible to input the type of ship or airplane and the like in a case of the sea route or the air route. Further, it may be possible to input a railway company, a shipping company, an airline company, or the like.

The “packing” is a condition regarding packing of the delivery item and is included in the condition related to the delivery method. For example, the user 1 selects “Simple” in a case where the delivery item is unlikely to be damaged. The user 1 selects “Securely” in a case where the user 1 does not wish others to see the delivery item. The user 1 selects “Precision” in a case where the delivery item is a precision instrument. Additionally, any packing methods may be specified.

It should be noted that the options for packing and the selection method are not limited. For example, a packing means that meets the need of the user 1, for example, selecting a waterproof package in a case where the user 1 wishes to keep the item dry, may be presented.

The “time” is a condition regarding the time taken for the delivery. For example, a condition to deliver the delivery item in at least one week is input. Alternatively, a condition indicating that the user 1 wishes to slowly deliver the delivery item for two weeks or more is input. Further, an arrival date may be specified and input as the “time”.

The “additional information” is a condition regarding information to be added to the delivery item (it can also be called added value). For example, a condition regarding the relevant object that the user wishes to obtain and a condition regarding the delivery route content provided to the recipient 3 are input. For example, what relevant object related to the move point on the delivery route the user wishes to obtain, what kind of delivery route content the user wishes to provide to the recipient 3, and the like are input.

For example, as described above with reference to FIG. 4, an instruction to obtain images and sounds of the delivery route via the Yankee Stadium (point A), the Liberty Island (point B), the Niagara Falls (point C), and the Shinagawa Station (point D) and specialty products related to the Yankee Stadium (point A), the Liberty Island (point B), the Niagara Falls (point C), and the Shinagawa Station (point D) as the relevant objects is input.

For example, it is also possible to input a condition indicating that the user 1 wishes to obtain a smell of rose as a specialty product of Bulgaria, which is input as the via-point, as the relevant object through the smell sensor, and to provide a perfume containing the smell as the delivery route content.

Further, it is also possible to input a condition indicating that the user 1 wishes to obtain a video obtained by imaging a sunrise or sunset at each point, a video obtained by imaging cats or dogs at each point, a video obtained by imaging children or families at each point, or the like as the relevant object, and to provide the one obtained by editing the video as the delivery route content. As a matter of course, it is also possible to specify a reproduction time (reproduction time of the video) and the like of the delivery route content. For example, the content providing unit 16 may edit the delivery route content (scene image) on the basis of the reproduction time specified by the user 1 (sender).

Alternatively, it is also possible to input a condition to provide a video that provides a feeling as if the recipient 3 travelled from the delivery end point to the delivery start point to the place where the user 1 is located as the delivery route content. Additionally, any conditions regarding editing the relevant object can be input.

The “delivery fee” is a condition regarding the delivery fee and a budget (upper limit amount) is input, for example. Alternatively, a lower limit amount and an upper limit amount may be input and a condition indicating that the user 1 wishes to perform the delivery of the delivery item and the provision of the delivery route content within this range of amount may be input.

Once the delivery condition is input, a determination button 9 is selected. It should be noted that it is unnecessary to input all delivery conditions shown in FIG. 6. For example, only the “delivery start point” and the “delivery end point” may be input and the determination button 9 may be selected.

In this embodiment, for example, Central Park is input as the “delivery start point” and the address of the recipient 3 is input as the “delivery end point”. Further, a zoo, Empire State Building, Times Square, Yankee Stadium, Statue of Liberty, JFK International Airport, Niagara Falls, San Francisco, Honolulu, Haneda Airport, and Shinagawa Station are specified as the “via-points”.

Further, two weeks are input as the “time” (the date after two weeks is input as the arrival date). Further, a big delivery company X and a local delivery company Y are input as the “delivery traders” and the “robust” is input as the “packing”. Further, images at the respective move points are captured as the “additional information” and an instruction to generate a video (reproduction time of 10 minutes) by editing the images is input.

The delivery condition input via the webpage for input 8 is received by the condition receiving unit 11 of the server apparatus 10. In Step 103, the delivery route calculating unit 12 and the fee calculating unit 13 optimize the delivery route on the basis of the received delivery conditions.

For example, the delivery route calculating unit 12 calculates an optimal delivery route for the “delivery start point”, the “via-points”, and the “delivery end point” input as the delivery conditions. For example, the delivery route is optimized to minimize the time for the delivery. Alternatively, the delivery route may be optimized to minimize the delivery fee for the delivery.

The fee calculating unit 13 calculates a delivery fee for the delivery route calculated by the delivery route calculating unit 12. The delivery fee is calculated on the basis of the input delivery conditions. The delivery route is optimized such that the calculated delivery fee meets the “delivery fee” which is one of the delivery conditions.

It should be noted that the “delivery trader”, the “delivery method”, the “route”, the “additional information”, and the like may be optimized as appropriate in the optimization of the delivery route. For example, in a case where no inputs for these delivery conditions are received from the user 1, the delivery route calculating unit 12 or the like automatically sets the “delivery trader” and the like.

Once the delivery route is optimized, the optimized delivery route and delivery fee are presented to user 1 (Step 104). Further, arrangements of the delivery trader that delivers the delivery item are made on the basis of the “delivery trader” which is one of the delivery conditions (Step 105).

When the presented delivery route/delivery fee is confirmed by the user 1 and the fee is paid, the delivery request is completed (Step 106). It should be noted that the payment method for the delivery fee is not limited.

It should be noted that it may be difficult to optimize the delivery route under some input delivery conditions. For example, in a case where a large number of intermediate points are input while delivery for a very short time at a low fee is requested, an optimal delivery route cannot be calculated. In such a case, for example, the user 1 is notified that the delivery route cannot be calculated, and is instructed to input delivery conditions anew. It should be noted that the user 1 may be notified of the descriptions of the delivery conditions to be changed or the like.

Any algorithms and the like may be employed as a technique for optimizing the delivery route. For example, any machine-learning algorithm using deep neural network (DNN) or the like may be used to optimize the delivery route. For example, the use of artificial intelligence (AI) using deep learning makes it possible to improve the accuracy in optimizing the delivery route.

FIG. 7 is a schematic diagram showing a configuration example of a webpage for route selection. In this embodiment, the candidate presenting unit 14 generates candidate route information including one or more candidate delivery routes that are candidates for the delivery route and delivery fees respectively depending on the one or more candidate delivery routes. A webpage 70 for route selection including the candidate route information is generated and sent to the user terminal 2.

In the example shown in FIG. 7, it is assumed that the user 1 instructs to display the candidate route information (to display the webpage 70 for route selection) in a state in which the “delivery start point”=(New York) and the “delivery end point”=(Shinagawa) are input.

The delivery route calculating unit 12 calculates candidate delivery routes from the “delivery start point” to the “delivery end point”. Further, the fee calculating unit 13 calculates delivery fees for the candidate delivery routes calculated by the delivery route calculating unit 12.

For example, as “Candidate 1”, a delivery route in which there is no via-points from the point a (New York) that is the delivery start point to the point b (Shinagawa) that is the delivery end point is displayed. For example, an optimal delivery route from New York to Shinagawa is calculated. The air route is selected as the delivery method and the delivery fee for the delivery is also displayed.

As “Candidate 2”, a delivery route in which point c (Honolulu) is set as the via-point is displayed. The delivery route calculating unit 12 calculates an optimal delivery route for New York, Honolulu, and Shinagawa. Then, each delivery method and the delivery fee are displayed together.

As “Candidate 3”, a delivery route in which the point c (Honolulu), the point d (Niagara), and the point e (San Francisco) are set as the via-points is displayed. The delivery route calculating unit 12 calculates an optimal delivery route for New York, Honolulu, Niagara, San Francisco, and Shinagawa. Then, each delivery method and the delivery fee are displayed together.

The user 1 selects one of “Candidate 1”, “Candidate 2”, or “Candidate 3”. Then, the delivery route and the delivery fee are determined, and the delivery request is completed after the delivery fee is paid. It should be noted that the specific calculation method for the candidate delivery route as illustrated in FIG. 7 is not limited, and a machine learning algorithm or the like may be used as appropriate. As a matter of course, the number of candidates to be displayed is not limited.

It is also possible to set a desired delivery route while alternately checking the webpage for input 8 illustrated in FIG. 6 and the webpage 70 for route selection illustrated in FIG. 7. For example, predetermined delivery conditions are input through the webpage for input 8 and an operation to display the candidate delivery routes is made.

The delivery route calculating unit 12 and the fee calculating unit 13 calculate the candidate delivery routes and the delivery fees on the basis of the currently input delivery conditions, and the webpage 70 for route selection is generated. The user 1 refers to the candidate delivery routes and the delivery charges displayed on the webpage 70 for route selection, and returns to the webpage for input 8 and inputs delivery conditions anew if necessary. Accordingly, it is possible to determine a desired optimal delivery route while checking the delivery fees.

It should be noted that the delivery fees under the current delivery conditions may be displayed in the webpage for input 8 illustrated in FIG. 6. Accordingly, it is possible to input each delivery condition while checking the delivery fees in the webpage for input 8.

Further, in the webpage for input 8 of FIG. 6, other candidates for the delivery condition may be displayed in accordance with the inputs of the “delivery start point”, the “via-points”, and the “delivery end point”. For example, candidates for the delivery trader that can take charge of the delivery may be displayed in accordance with the inputs of the “delivery start point”, the “via-points”, and the “delivery end point”. The user 1 may then select one of the delivery traders shown as the candidates. For example, in a case of determining a delivery trader by an input method, delivery traders that are likely to respond to a bid are shown as candidates.

Further, for example, a shortest possible delivery time may be calculated and displayed in accordance with the inputs of the “delivery start point”, the “via-points”, and the “delivery end point”. Accordingly, the user 1 can input a time for the delivery on the basis of the shortest time. Further, candidates for available relevant objects and delivery route content that can be generated may be displayed as conditions of the “additional information”.

The delivery conditions are not limited to those illustrated in FIG. 6 and it may be possible to input any other conditions regarding the delivery of the delivery item.

The delivery person 5 in charge of the “custom distribution service” comes to pick up the gift that is the delivery item of the user 1 (Step 107). The delivery person 5 stores the delivery item from the user 1 in the dedicated box 40.

The user 1 makes a video letter through the camera 42, saying the message, “You will receive my gift with a movie of the travel about two weeks later, so look forward to it” toward the camera 102 mounted on the dedicated box 40. This video letter is also included in the relevant object related to the move point of the delivery item.

The delivery person 5 passes the delivery item to the local delivery company Y. In Step 108, the local delivery company Y moves on the delivery route in accordance with the place to go displayed on the panel corresponding to the display unit 44. The place to go is displayed by a predetermined function block of the server apparatus 10. For example, information regarding the current location is sent from the GPS 47 of the dedicated box 40. On the basis of the information regarding the current location, the server apparatus 10 sends to the dedicated box 40 information regarding the next move point to move to. Accordingly, it is possible to smoothly carry out the delivery through the via-points.

Further, in accordance with instruction contents of the display unit 44 that displays a signal (e.g., imaging instruction) from the instruction output unit 15, the delivery person 5 of the local delivery company Y stops at a place where the signal is made and captures an ambient image. As a matter of course, the imaging instruction for capturing the ambient image may be output to the camera 42 on the basis of the information regarding the current location from GPS 47. Then, the camera 42 may automatically capture the ambient image.

The delivery item is delivered by the local delivery company Y to the JFK International Airport (Step 110). The delivery item is sent from the JFK International Airport to Toronto and passed to the big delivery company X. The delivery person 5 of the big delivery company X moves on the delivery route, following instructions displayed on the display unit 44. Then, on the basis of an imaging instruction or the like displayed on the display unit 44 captures an ambient image at a predetermined position. As a matter of course, the imaging may be automatically performed.

After passing through the set via-points, the delivery item is delivered to the recipient 3 at the delivery end point (Step 112). At this time, an image or the like of the recipient 3 may be captured as a relevant object at the delivery end point.

When the delivery item is passed to each delivery trader or the recipient 3, the captured images (relevant objects) obtained by the camera 42 are sent to the server apparatus 10 as an additional information report (Steps 109, 111, and 113).

The timing at which the relevant object is sent to the server apparatus 10 is not limited. For example, the relevant object may be sent to the server apparatus 10 in a place where the communication speed of the network line is high, such as an airport. On the basis of a detection result of the communication speed sensor 50, it is possible to determine a state in which the communication speed is high.

It should be noted that as described above, the method of obtaining the relevant objects is not limited to imaging by the camera 42 of the dedicated box 40. The images that are the relevant objects may be obtained by a camera as an on-board apparatus mounted on a truck, an airplane, or the like delivering the delivery item, a surveillance camera as a fixed apparatus on the delivery route, an IC camera, and the like.

The relevant objects obtained by the time when the delivery is completed are edited by the content providing unit 16 of the server apparatus 10. In this embodiment, the image data captured at each move point of the delivery item is edited, and a movie having a reproduction time of 10 minutes is generated as the delivery route content (Step 114). For example, the content providing unit 16 may compress a video section corresponding to a route between the specific landscapes into a time-lapse video and generate video content showing a continuous section from the start point to the end point of the delivery route. With this configuration, the recipient 3 can more realistically experience the feeling of traveling on the delivery route. Alternatively, the content providing unit 16 may cooperate with the output unit 15 to control the relevant apparatus (imaging apparatus) such that the driving time of the relevant apparatus is within 10 minutes. With this configuration, the content providing unit 16 (server apparatus 10) is capable of generating the delivery route content while achieving the power saving of the relevant apparatus. Alternatively, the content providing unit 16 may generate the delivery route content by deleting the video section corresponding to the route between the specific landscapes as appropriate.

Further, when the delivery to the recipient 3 is completed, the user 1 and the recipient 3 receive a mail from the “custom distribution service” (Steps 115 and 116). The mail includes a delivery completion notification and an additional information completion notification. The additional information completion notification is information indicating that the delivery route content is completed, and in this embodiment, a URL accessible to the movie is notified.

The user 1 and recipient 3 can view videos of the respective locations on the delivery route through which the delivery item has gone by accessing the URL contained in the received mail (Steps 117 and Step 118).

It should be noted that the mail-sending method is not limited. For example, an account of the recipient 3 may be registered in advance, and an e-mail may be sent there. Further, instead of sending the e-mail, a letter or the like containing the URL may be put inside the dedicated box 40.

It should be noted that in Step 307 and the like, information regarding the move points and information regarding a delivery state and the like may be sent as the relevant objects as the additional information report. Further, the information regarding the delivery state may be sent to the user 1.

Further, the delivery route content (movie) generated by the content providing unit 16 may be sent to the user 1 such that the user 1 can check it. Further, the delivery route content may be editable by the user 1.

Further, while the delivery item is being delivered, the user 1 may additionally specify relevant objects, for example. For example, it may be possible to additionally specify obtaining a specialty product or the like at the move point where the delivery item has been moved. In this case, notification, confirmation, and the like of addition of the delivery fee and the like may be performed between the server apparatus 10 and the user terminal 2.

FIG. 8 is a flowchart showing an example of obtaining the relevant object based on the state information. With the dedicated box 40 according to this embodiment, the ambient images can be automatically captured as the relevant objects on the basis of the state information detected by the GPS 47, the illuminance sensor 48, and the like.

As shown in FIG. 8, whether or not a trigger for imaging is detected is monitored on the basis of the state information detected by the respective sensors mounted on the dedicated box 40 (Step 201). When the trigger for imaging is detected, the camera 42 captures an ambient image and obtains it as a relevant object (Step 202).

FIG. 9 is a flowchart showing an example of the trigger for imaging.

In the example shown in FIG. 9, whether the acceleration has changed is first determined on the basis of a detection result by the acceleration sensor 48 (Step 301). Then, in a case where the acceleration has changed, the camera 42 captures an ambient image (Step 306). For example, an ambient image is captured when the movable object that delivers the delivery item starts moving from a stationary state for departure or the like, when a sudden brake is applied in a moving state, or the like. Accordingly, an image in a case where a certain event occurs or the like can be captured in some cases.

On the basis of a detection result by the illuminance sensor 48, whether or not the illuminance has changed is determined (Step 302). In a case where the illumination has changed, the camera 42 captures an ambient image (Step 306).

For example, in a case where the dedicated box 40 is placed in a cargo room or the like and it is dark around the dedicated box 40 or the like, unnecessary imaging can be prevented. In a case where it suddenly becomes bright around the dedicated box 40, there is a possibility that the dedicated box 40 has moved out of the cargo room or the like, and thus, imaging is performed after a while. Accordingly, an image when arriving at a predetermined move point can be captured in some cases.

Further, in a case where it gradually becomes darker around the dedicated box 40, there is a possibility that an image of a sunset can be captured, and thus, time-lapse imaging is performed at intervals. Similarly, in a case where it gradually becomes brighter around the dedicated box 40, there is a possibility that an image of a sunrise can be captured, and thus time-lapse imaging is performed at intervals. Accordingly, beautiful images of the sunset and the sunrise at the respective move points can be captured in some cases.

In a case where a loud sound near the dedicated box 40 on the basis of a sound collection result by the microphone 45, the camera 42 captures an ambient image (Yes in Step 303, Step 306). Accordingly, for example, an image in a case where a happening such as an accident occurs or the like can be captured in some cases. Further, images of fireworks suddenly launched or the like can be captured in some cases.

In a case where the dedicated box 40 is located at the predetermined position on the basis of information regarding a current location detected by the GPS 47, the camera 42 captures an ambient image (Yes in Step 304, Step 306). Accordingly, for example, it is possible to capture an ambient image when the dedicated box 40 is close to a place specified by the user 1 in advance or when the dedicated box 40 is in the specified place.

Further, in a case where an altitude can be detected as the position of the dedicated box 40, when the position of the dedicated box 40 exceeds a certain height from a low position, imaging is performed because there is a possibility that the visibility is improved. Accordingly, a beautiful scene can be captured in some cases.

When the communication unit 51 receives an imaging instruction from the instruction output unit 15, the camera 42 captures an ambient image (Yes in Step 305, Step 306). Accordingly, it is possible to obtain an image of a particular point which is a predetermined condition input by the user 1. It should be noted that it is possible to capture not only an image of a point input first by the user 1 but also an image of a point newly input later.

In this manner, by setting the trigger for imaging, it is possible to obtain the relevant object related to the delivery route on which the delivery item is delivered in real time, and it is possible to obtain an image or the like of the time zone near the move point to which the delivery item has been delivered.

It should be noted that the order of the respective steps of the flowchart and the determination contents are not limited. The type of trigger for imaging and the like are not limited as long as the state near the delivery item can be obtained in real time as the relevant object.

Further, the contents of the imaging trigger may be set in a manner that depends on the type of sensor mounted on the dedicated box 40. For example, when the user 1 wishes to send smells of the via-points or the like as additional information to the recipient 3, an apparatus (smell sensor) that detects a smell may be mounted in the dedicated box 40. Further, articles or the like with which the smells of the via-points or the like can be felt may be delivered.

Further, the determination method for the imaging trigger and the like may be controlled in accordance with the route on which the delivery item is delivered. For example, in a case where the dedicated box 40 is delivered by sea route, imaging is performed as the illuminance becomes low. In the case of the air route, imaging is performed when the illuminance takes a certain value and there is no change in acceleration. In the case of the land route, imaging is performed when the illuminance and the acceleration change suddenly and greatly. Such an imaging method according to the route may be set as appropriate. Accordingly, it is possible to obtain an optimal relevant object according to the route.

As described above, in the server apparatus 10 according to this embodiment, the delivery route for delivering the delivery item is determined. Instructions for obtaining, during delivery of the delivery items, relevant objects related to intermediate points between the start and end points of the determined delivery route are output to the respective cameras included in the dedicated box 40 and the external camera system 60. Accordingly, it is possible to additionally provide the relevant objects related to the intermediate points in addition to the delivery of the delivery item. As a result, a new delivery service can be realized.

A video of the delivery route or the like which is provided as content is obtained as a video in which the delivery item approaches the recipient 3 from the user 1, for example, because the delivery item is generally sent from the user 1 to the recipient 3. By changing the setting of editing the video, it is possible to edit the video such that the delivery item approaches from the recipient 3 to the user 1, i.e., the delivery item goes back on the same route, for example. Accordingly, it is possible for the recipient 3 to have a simulated experience of the travel to the place where the user 1 lives.

The relevant objects such as images obtained when delivering the delivery item are sent to the server apparatus 10 as appropriate. Accordingly, it is possible to also expect security and traceability effects for evidence of where the delivery item has been actually sent, whether the delivery item has been handled roughly, and the like.

### Other Embodiments

The present technology is not limited to the above-mentioned embodiment and various other embodiments can be made.

In the above-mentioned embodiment, the instruction output unit 15 outputs the instruction such that the ambient images and the like of the dedicated box 40 are obtained in real time. The present technology is not limited thereto, and in a case where a real-time image related to the via-point of the delivery item cannot be obtained, image data on the Internet, an existing photograph used in a brochure or the like, or an image of a time zone in which a delivery item passed through the via-point on a date different from the date on which the delivery item passed through the via-point may be used.

Further, for example, the instruction output unit 15 may output an instruction for storing the item related to the additional information in the dedicated box 40. Further, control may be performed no to perform imaging in a manner that depends on the contents detected by the sensor.

In the above-mentioned embodiment, the dedicated box 40 is constituted by the baggage storage portion 41, the camera 42, the battery 43, the display unit 44, the microphone 45, the speaker 46, the GPS 47, the illuminance sensor 48, the acceleration sensor 49, the communication speed sensor 50, the communication unit 51, and the control processing unit 52. The present technology is not limited thereto, and the cameras, the sensors, and the like may be changed as appropriate as long as the dedicated box 40 is configured to be capable of obtaining the relevant objects.

For example, in a case where a configuration in which the user 1 obtains a smell of each via-point as a relevant object is employed, a device that detects a smell or the like may be mounted on the dedicated box 100. Accordingly, it is possible to sense smells and the like of the via-points and the delivery route through which the delivery item has passed, and it is possible to feel the atmosphere of the via-points and the like.

In the above-mentioned embodiment, the car, the railway, the ship, and the airplane are used as the delivery methods for the delivery route. The present technology is not limited thereto, and the movable object that delivers the delivery item along the delivery route connecting the delivery start point, the delivery end point, and the via-points may be a motorcycle, a carriage, or the like. This may be optionally selectable by the user 1.

A computer mounted on the dedicated box or a computer carried by the delivery person may cooperate with another computer (cloud system) capable of communication via a network or the like to thereby execute the information processing method and the program according to the present technology and construct the information processing apparatus according to the present technology.

That is, the information processing method and the program according to the present technology can be executed not only in a computer system configured by a single computer but also in a computer system in which a plurality of computers cooperate each other. It should be noted that in the present disclosure, the system means a set of components (such as apparatuses and modules (parts)) and it does not matter whether all of the components are in a single casing. Therefore, a plurality of apparatuses housed in separate casings and connected to one another via a network and a single apparatus having a plurality of modules housed in a single casing are both the system.

Execution of the information processing method and the program according to the present technology by the computer system includes, for example, both a case where calculation of the delivery route for delivering the delivery item, instruction for obtaining the relevant object related to the move point of the delivery, obtaining of the state information related to the delivery route to which the delivery item is delivered, and the like are performed by a single computer and a case where the respective processes are performed by different computers. Further, performing the respective processes by a predetermined computer includes causing another computer to perform some or all of those processes and obtaining results thereof.

The respective configurations of the server apparatus, the dedicated box, and the like described above with reference to the drawings, the control flow of the control processing unit, and the like are merely one embodiment, and can be arbitrarily modified without departing from the gist of the present technology. That is, any other configurations, algorithms, and the like for carrying out the present technology may be employed.

At least two of the features according to the present technology described above may be combined. In other words, various features described in the respective embodiments may be arbitrarily combined across the embodiments. Further, the various effects described above are merely illustrative, not limitative, and other effects may be provided.

It should be noted that the present technology can also take the following configurations.

(1) An information processing apparatus, including:

a calculating unit that calculates a delivery route for delivering a delivery item; and

an output unit that outputs an instruction for obtaining, during delivery of the delivery item, a relevant object related to an intermediate point between a start point of the delivery route and an end point of the delivery route to a relevant apparatus located at the intermediate point.

(2) The information processing apparatus according to (1), in which

the relevant object includes at least one of a scene image of the intermediate point, an environmental sound of the intermediate point, a smell of the intermediate point, and a real object located at the intermediate point.

(3) The information processing apparatus according to (1) or (2), further including

a content providing unit that provides a recipient of the delivery item with content related to the delivery route on the basis of the relevant object obtained by the relevant apparatus.

(4) The information processing apparatus according to (3), in which

the content providing unit generates image content obtained by editing at least one of scene images captured at a plurality of intermediate points each of which is the intermediate point.

(5) The information processing apparatus according to (4), in which

the content providing unit edits the scene image on the basis of a reproduction time specified by a sender of the delivery item.

(6) The information processing apparatus according to (3) to (5), in which

the content providing unit that outputs, in a case where the recipient receives the delivery item, access information for accessing the content to a terminal owned by the recipient.

(7) The information processing apparatus according to (1) to (6), in which

the relevant apparatus includes at least one of a movable apparatus that is movable to the intermediate point together with the delivery item or a fixed apparatus installed at the intermediate point.

(8) The information processing apparatus according to (7), in which

the relevant apparatus includes at least the movable apparatus, and

the movable apparatus includes at least one of a storage apparatus that stores the delivery item, a portable apparatus that is capable of being carried by a deliverer who delivers the delivery item, or a mounted apparatus that is mounted on a movable object that transports the delivery item.

(9) The information processing apparatus according to (1) to (8), in which

the output unit outputs at least one of an imaging instruction to an imaging apparatus located at the intermediate point, a sound recording instruction to a sound recording apparatus located at the intermediate point, a smell detecting instruction to a smell sensor located at the intermediate point, or an output instruction regarding obtaining a real object to the relevant apparatus located at the intermediate point.

(10) The information processing apparatus according to (1) to (9), in which

the output unit outputs an instruction for obtaining the relevant object in real time.

(11) The information processing apparatus according to (1) to (10), in which

the calculating unit calculates the delivery route including a plurality of specific landscapes as the intermediate point on the basis of the start point of the delivery route and the end point of the delivery route specified by a sender of the delivery item.

(12) The information processing apparatus according to (11), in which

the output unit outputs instructions for obtaining relevant objects to relevant apparatuses of a plurality of self-employed couriers respectively corresponding to the plurality of specific landscapes.

(13) The information processing apparatus according to any one of (1) to (12), further including

a receiving unit that receives a condition related to the delivery of the delivery item, the condition being input from a sender of the delivery item, in which

the calculating unit calculates the delivery route on the basis of the received condition related to the delivery.

(14) The information processing apparatus according to (13), in which

the condition related to the delivery includes a condition related to at least one of the intermediate point of the delivery route or the relevant object that is wished to be obtained.

(15) The information processing apparatus according to (1) to (14), further including

a presenting unit capable of presenting to a sender of the delivery item candidate route information including a plurality of candidate delivery routes that are candidates for the delivery route and delivery fees respectively depending on the plurality of candidate delivery routes.

(16) An information processing method, including:

by at least one processor

calculating a delivery route for delivering a delivery item; and

outputting an instruction for obtaining, during delivery of the delivery item, a relevant object related to an intermediate point located between a start point of the delivery route and an end point of the delivery route to a relevant apparatus located at the intermediate point.

(17) A program that causes at least one processor to perform:

a step of calculating a delivery route for delivering a delivery item; and

a step of outputting an instruction for obtaining, during delivery of the delivery item, a relevant object related to an intermediate point located between a start point of the delivery route and an end point of the delivery route to a relevant apparatus located at the intermediate point.

(18) A storage apparatus, including:

a storage portion capable of storing a delivery item;

a receiving unit that receives an instruction for obtaining, during delivery of the delivery item, a relevant object related to an intermediate point located between a start point of the delivery route and an end point of the delivery route from an information processing apparatus;

an obtaining unit capable of obtaining data regarding the relevant object on the basis of the instruction; and

a sending unit that sends the data regarding the relevant object to the information processing apparatus.

(19) The storage apparatus according to (18), further including

a sensor unit that detects state information related to a delivery state of the storage apparatus, in which

the obtaining unit obtains the relevant object on the basis of the state information.

(20) The storage apparatus according to (19), in which

the state information includes at least one of a current location, an ambient illuminance, an ambient sound, acceleration, or a communication speed.

(21) The storage apparatus according to any one of (18) to (20), in which

the obtaining unit includes at least one of an imaging apparatus capable of capturing a scene image of the intermediate point or a sound recording apparatus capable of obtaining an environmental sound of the intermediate point.

### REFERENCE SIGNS LIST

2 user terminal
4 recipient terminal
10 server apparatus
11 condition receiving unit
12 delivery route calculating unit
13 fee calculating unit
14 candidate presenting unit
15 instruction output unit
16 content providing unit
30 portable terminal
40 dedicated box
41 baggage storing unit
42 camera
45 microphone
47 GPS
48 illuminance sensor
49 acceleration sensor
50 communication speed sensor
51 communication unit
52 control processing unit
60 external camera system

1. An information processing apparatus, comprising:
a calculating unit that calculates a delivery route for delivering a delivery item; and
an output unit that outputs an instruction for obtaining, during delivery of the delivery item, a relevant object related to an intermediate point between a start point of the delivery route and an end point of the delivery route to a relevant apparatus located at the intermediate point.

2. The information processing apparatus according to claim 1, wherein
the relevant object includes at least one of a scene image of the intermediate point, an environmental sound of the intermediate point, a smell of the intermediate point, and a real object located at the intermediate point.

3. The information processing apparatus according to claim 1, further comprising
a content providing unit that provides a recipient of the delivery item with content related to the delivery route on a basis of the relevant object obtained by the relevant apparatus.

4. The information processing apparatus according to claim 3, wherein
the content providing unit generates image content obtained by editing at least one of scene images captured at a plurality of intermediate points each of which is the intermediate point.

5. The information processing apparatus according to claim 4, wherein
the content providing unit edits the scene image on a basis of a reproduction time specified by a sender of the delivery item.

6. The information processing apparatus according to claim 3, wherein
the content providing unit that outputs, in a case where the recipient receives the delivery item, access information for accessing the content to a terminal owned by the recipient.

7. The information processing apparatus according to claim 1, wherein
the relevant apparatus includes at least one of a movable apparatus that is movable to the intermediate point together with the delivery item or a fixed apparatus installed at the intermediate point.

8. The information processing apparatus according to claim 7, wherein
the relevant apparatus includes at least the movable apparatus, and
the movable apparatus includes at least one of a storage apparatus that stores the delivery item, a portable apparatus that is capable of being carried by a deliverer who delivers the delivery item, or a mounted apparatus that is mounted on a movable object that transports the delivery item.

9. The information processing apparatus according to claim 1, wherein
the output unit outputs at least one of an imaging instruction to an imaging apparatus located at the intermediate point, a sound recording instruction to a sound recording apparatus located at the intermediate point, a smell detecting instruction to a smell sensor located at the intermediate point, or an output instruction regarding obtaining a real object to the relevant apparatus located at the intermediate point.

10. The information processing apparatus according to claim 1, wherein
the output unit outputs an instruction for obtaining the relevant object in real time.

11. The information processing apparatus according to claim 1, wherein
the calculating unit calculates the delivery route including a plurality of specific landscapes as the intermediate point on a basis of the start point of the delivery route and the end point of the delivery route specified by a sender of the delivery item.

12. The information processing apparatus according to claim 11, wherein
the output unit outputs instructions for obtaining relevant objects to relevant apparatuses of a plurality of self-employed couriers respectively corresponding to the plurality of specific landscapes.

13. The information processing apparatus according to claim 1, further comprising
a receiving unit that receives a condition related to the delivery of the delivery item, the condition being input from a sender of the delivery item, wherein
the calculating unit calculates the delivery route on a basis of the received condition related to the delivery.

14. The information processing apparatus according to claim 13, wherein
the condition related to the delivery includes a condition related to at least one of the intermediate point of the delivery route or the relevant object that is wished to be obtained.

15. The information processing apparatus according to claim 1, further comprising
a presenting unit capable of presenting to a sender of the delivery item candidate route information including a plurality of candidate delivery routes that are candidates for the delivery route and delivery fees respectively depending on the plurality of candidate delivery routes.

16. An information processing method, comprising:
by at least one processor
calculating a delivery route for delivering a delivery item; and
outputting an instruction for obtaining, during delivery of the delivery item, a relevant object related to an intermediate point located between a start point of the delivery route and an end point of the delivery route to a relevant apparatus located at the intermediate point.

17. A program that causes at least one processor to perform:
a step of calculating a delivery route for delivering a delivery item; and
a step of outputting an instruction for obtaining, during delivery of the delivery item, a relevant object related to an intermediate point located between a start point of the delivery route and an end point of the delivery route to a relevant apparatus located at the intermediate point.

18. A storage apparatus, comprising:
a storage portion capable of storing a delivery item;
a receiving unit that receives an instruction for obtaining, during delivery of the delivery item, a relevant object related to an intermediate point located between a start point of the delivery route and an end point of the delivery route from an information processing apparatus;
an obtaining unit capable of obtaining data regarding the relevant object on a basis of the instruction; and
a sending unit that sends the data regarding the relevant object to the information processing apparatus.

19. The storage apparatus according to claim 18, further comprising
a sensor unit that detects state information related to a delivery state of the storage apparatus, wherein
the obtaining unit obtains the relevant object on a basis of the state information.

20. The storage apparatus according to claim 19, wherein
the state information includes at least one of a current location, an ambient illuminance, an ambient sound, acceleration, or a communication speed.

21. The storage apparatus according to claim 18, wherein
the obtaining unit includes at least one of an imaging apparatus capable of capturing a scene image of the intermediate point or a sound recording apparatus capable of obtaining an environmental sound of the intermediate point.
